(19) United States
(12) Patent Application Publication
(10) Pub. No.: US 2012/0308195 A1
(43) Pub. Date: Dec. 6, 2012

(54) FEEDBACK SYSTEM AND METHOD

(76) Inventors: MICHAEL BANNAN, Vista, CA (US); Jason Davis, Rancho Santa Fe, CA (US)

(21) Appl. No.: 13/484,872

(22) Filed: May 31, 2012

Related U.S. Application Data
(60) Provisional application No. 61/491,545, filed on May 31, 2011.

(51) Int. Cl. H04N 5/775

(52) U.S. Cl. 386/230; 386/E05.07

(57) ABSTRACT

A method, computer program product, and computer system for receiving a video at a computer device. The video includes a plurality of time codes corresponding to a plurality of video segments of the video. At least a portion of the plurality of video segments is played via a user interface operating on the computer device. A comment corresponding to a first video segment of the plurality of video segments is received via the user interface. The comment is associated with a first time code of the plurality of time codes, where the first time code corresponds to the first video segment. The comment is synchronized with playback of the video.

### RELATED CASES

This application claims the benefit of U.S. Provisional Application No. 61/491,545, filed on 31 May 2011, by Bannan et al, entitled Feedback System and Method, the contents of which is incorporated by reference.

### TECHNICAL FIELD

This disclosure relates to feedback systems and methods.

### BACKGROUND

Educators may teach new skills to one or more students. Such skills may include, for example, reading, writing, science, mathematics, etc. The educators may then provide the students with written or verbal tests so as to determine the level of mastery of the new skills.

However, some skills may require evaluations other than (or in addition to) written or verbal tests. For example, the educator may be present when the student is performing laboratory procedures to ensure that the procedures are performed using the appropriate techniques. As another example, an educator may be present when the student is giving an in-person presentation to evaluate its content or evaluate the presentation style of the student.

### SUMMARY OF DISCLOSURE

In one implementation, a method, performed by one or more computing devices, comprises receiving a video at a computer device. The video includes a plurality of time codes corresponding to a plurality of video segments of the video. At least a portion of the plurality of video segments is played via a user interface operating on the computer device. A comment corresponding to a first video segment of the plurality of video segments is received via the user interface. The comment is associated with a first time code of the plurality of time codes, where the first time code corresponds to the first video segment. The comment is synchronized with playback of the video.

One or more of the following features may be included. Synchronizing the comment with the playback of the video may include displaying the comment associated with the first time code in-time with the playback of the first video segment of the video. The comment associated with the first time code may be displayed via the user interface. A selection of the comment associated with the first time code may be received via the user interface. The first video segment may be played at the corresponding first time code in response to receiving the selection of the comment. A marker of the video may be displayed via the user interface. The marker may correspond to the first time code. A selection of the marker of the video corresponding to the first time code may be received via the user interface. The first video segment may be played at the corresponding first time code in response to receiving the selection of the marker. The comment associated with the first time code may be displayed via the user interface in response to receiving the selection of the marker. The comment may include at least one of text, audio, and video. A notification may be received at the computer device that at least the portion of the video is available for review. The user interface may include at least one of a video player, an entry box to receive the comment, a comment list to display the comment, a value of the comment, and a grade.

In another implementation, a computer program product resides on a computer readable storage medium that has a plurality of instructions stored on it. When executed by a processor, the instructions cause the processor to perform operations comprising receiving a video. The video includes a plurality of time codes corresponding to a plurality of video segments of the video. At least a portion of the plurality of video segments is played via a user interface. A comment corresponding to a first video segment of the plurality of video segments is received via the user interface. The comment is associated with a first time code of the plurality of time codes, where the first time code corresponds to the first video segment. The comment is synchronized with playback of the video.

One or more of the following features may be included. Synchronizing the comment with the playback of the video may include displaying the comment associated with the first time code in-time with the playback of the first video segment of the video. The comment associated with the first time code may be displayed via the user interface. A selection of the comment associated with the first time code may be received via the user interface. The first video segment may be played at the corresponding first time code in response to receiving the selection of the comment. A marker of the video may be displayed via the user interface. The marker may correspond to the first time code. A selection of the marker of the video corresponding to the first time code may be received via the user interface. The first video segment may be played at the corresponding first time code in response to receiving the selection of the marker. The comment associated with the first time code may be displayed via the user interface in response to receiving the selection of the marker. The comment may include at least one of text, audio, and video. A notification may be received that at least the portion of the video is available for review. The user interface may include at least one of a video player, an entry box to receive the comment, a comment list to display the comment, a value of the comment, and a grade.

In another implementation, a computing system includes a processor and memory configured to perform operations comprising receiving a video. The video includes a plurality of time codes corresponding to a plurality of video segments of the video. At least a portion of the plurality of video segments is played via a user interface. A comment corresponding to a first video segment of the plurality of video segments is received via the user interface. The comment is associated with a first time code of the plurality of time codes, where the first time code corresponds to the first video segment. The comment is synchronized with playback of the video.

One or more of the following features may be included. Synchronizing the comment with the playback of the video may include displaying the comment associated with the first time code in-time with the playback of the first video segment of the video. The comment associated with the first time code may be displayed via the user interface. A selection of the comment associated with the first time code may be received via the user interface. The first video segment may be played at the corresponding first time code in response to receiving the selection of the comment. A marker of the video may be displayed via the user interface. The marker may correspond to the first time code. A selection of the marker of the video corresponding to the first time code may be received via the user interface. The first video segment may be played at the corresponding first time code in response to receiving the selection of the marker. The comment associated with the first time code may be displayed via the user interface in response to receiving the selection of the marker. The comment may include at least one of text, audio, and video. A notification may be received that at least the portion of the video is available for review. The user interface may include at least one of a video player, an entry box to receive the comment, a comment list to display the comment, a value of the comment, and a grade.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of a feedback process coupled to a distributed computing network;

FIG. 2 is an illustrative flowchart of the feedback process of FIG. 1;

FIG. 3 is an illustrative diagrammatic view of a screen image displayed by the feedback process of FIG. 1;

FIG. 4 is an illustrative diagrammatic view of a screen image displayed by the feedback process of FIG. 1;

FIG. 5 is an illustrative diagrammatic view of a screen image displayed by the feedback process of FIG. 1;

FIG. 6 is an illustrative diagrammatic view of a screen image displayed by the feedback process of FIG. 1; and

FIG. 7 is an illustrative diagrammatic view of a screen image displayed by the feedback process of FIG. 1.

Like reference symbols in the various drawings indicate like elements.

### DETAILED DESCRIPTION OF THE EMBODIMENTS

### System Overview:

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by one or more computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or combinations thereof.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

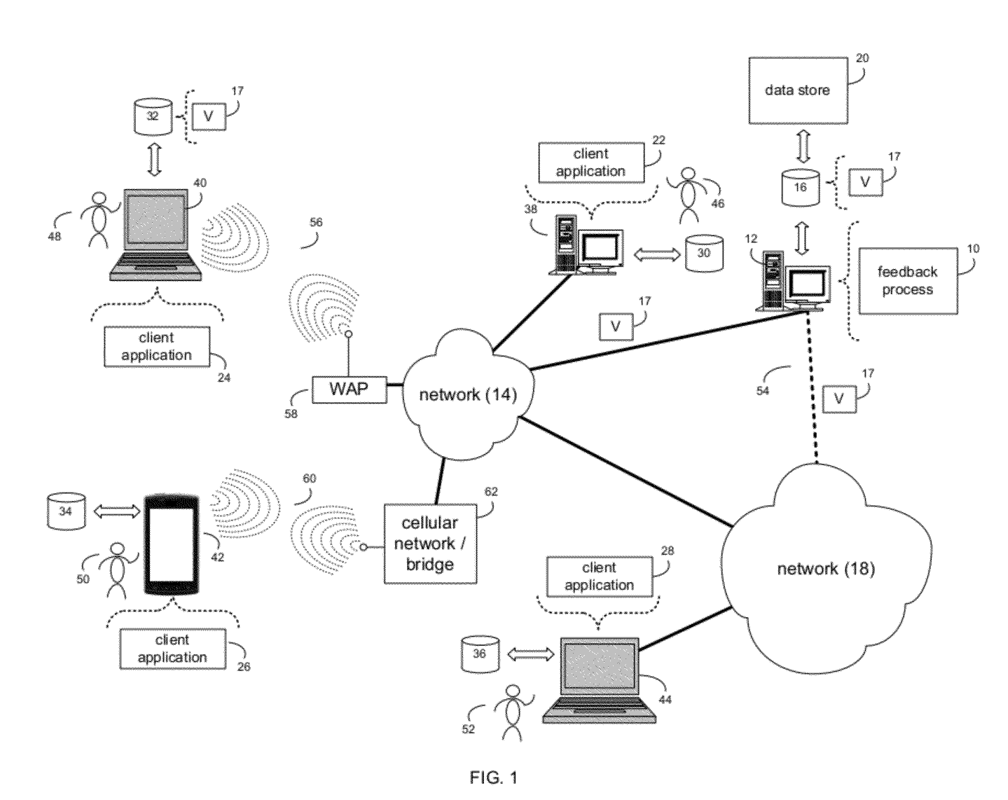

Referring to FIG. 1, there is shown feedback process 10 that may reside on and may be executed by computer 12, which may be connected to network 14 (e.g., the internet or a local area network). Examples of client computer 12 may include, but are not limited to, a personal computer(s), a laptop computer(s), mobile computing device(s), a server computer, a series of server computers, a mainframe computer(s), or a computing cloud(s). Client computer 12 may execute an operating system, for example, but not limited to Microsoft® Windows®; Mac® OS X®; Red Hat® Linux®, or a custom operating system, for example. (Microsoft and Windows are registered trademarks of Microsoft Corporation in the United States, other countries or both; Mac and OS X registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, feedback process 10 may receive a video at a computer device. The video may include a plurality of time codes that may correspond to a plurality of video segments of the video. At least a portion of the plurality of video segments may be played via a user interface operating on the computer device. A comment corresponding to a first video segment of the plurality of video segments may be received via the user interface. The comment may be associated with a first time code of the plurality of time codes, where the first time code may correspond to the first video segment. The comment may be synchronized with playback of the video.

The instruction sets and subroutines of feedback process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store 20, such as a database (e.g., relational database) and may be located within any suitable memory location, such as storage device 16 coupled to computer 12. In some embodiments, computer 12 may utilize a database management system such as, but not limited to, “My Structured Query Language” (MySQL) in order to provide multi-user access to one or more databases, such as the above noted relational database. The data store may also be a custom database, such as, for example, a flat file database or an XML database. Any other form(s) of a data storage structure may also be used. Feedback process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Feedback process 10 may be a stand alone application, or may be an applet/application/script that may interact with and/or be executed within one or more other applications executed by, e.g., computer 12. Examples of client applications 22, 24, 26, 28 may include but are not limited to a standard and/or mobile web browser, email client application, textual and/or graphical user interface, a customized web browser, or a custom application. The instruction sets and subroutines of client applications 22, 24, 26, 28, which may be stored on storage devices 30, 32, 34, 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, personal computer 38, laptop computer 40, smart phone 42, notebook computer 44, a tablet (not shown), a server (not shown), a data-enabled, cellular telephone (not shown), a television (not shown) with one or more processors embedded therein or coupled thereto, and a dedicated network device (not shown).

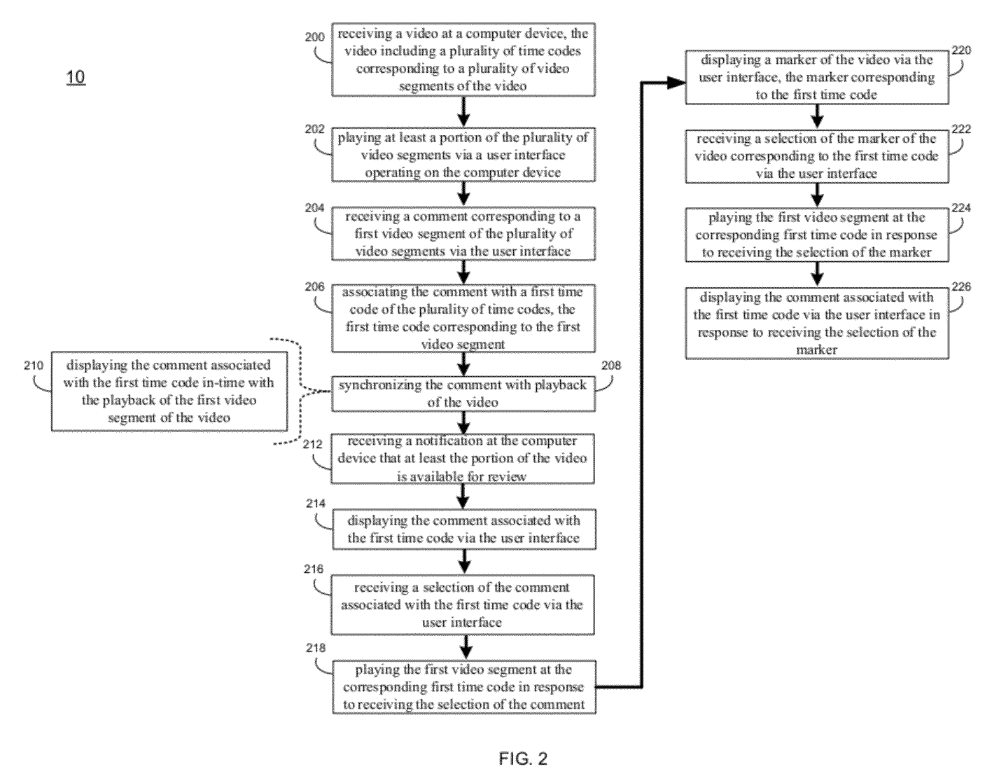

One or more of client applications 22, 24, 26, 28 may be configured to effectuate some or all of the functionality of feedback process 10 (and vice versa) and/or may include at least some of feedback process 10 (and vice versa). Accordingly, feedback process 10 may be a purely server-side application, a purely client-side application, or a hybrid server-side/client-side application that is cooperatively executed by one or more of client applications 22, 24, 26, 28 and feedback process 10. Feedback process 10 may include one or more user interfaces (e.g., user interface 300 shown in FIG. 2), such as browsers and textual or graphical user interfaces, through which users 46, 48, 50, 52 may access feedback process 10. User interface 300 may be a component of feedback process 10, a stand alone application that interfaces with feedback process 10 and/or an applet/application that is accessed via client applications 22, 24, 26, 28. Additionally, one or more of client applications 22, 24, 26, 28 may be configured to effectuate some or all of the functionality of user interface 300 (and vice versa) and/or may include at least some of user interface 300 (and vice versa). Accordingly, user interface 300 may be a purely server-side application, a purely client-side application, or a hybrid server-side/client-side application that is cooperatively executed by one or more of client applications 22, 24, 26, 28, feedback process 10, and/or user interface 300.

Users 46, 48, 50, 52 may access computer 12 and feedback process 10 directly through network 14 or through secondary network 18. Further, computer 12 may be connected to network 14 through secondary network 18, as illustrated with phantom link line 54. Feedback process 10 may include one or more user interfaces, such as browsers and textual or graphical user interfaces, through which users 46, 48, 50, 52 may access feedback process 10.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth™ device that is capable of establishing wireless communication channel 56 between laptop computer 40 and WAP 58. Smart phone 42 is shown wirelessly coupled to network 14 via wireless communication channel 60 established between smart phone 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth™ is a telecommunications industry specification that allows, e.g., mobile phones, computers, smart phones, and other electronic devices to be interconnected using a short-range wireless connection.

Client electronic devices 38, 40, 42, 44 may each execute an operating system, examples of which may include but are not limited to Android™, Apple® iOS™, Microsoft® Windows®, Linux®, or a custom operating system.

### The Feedback Process:

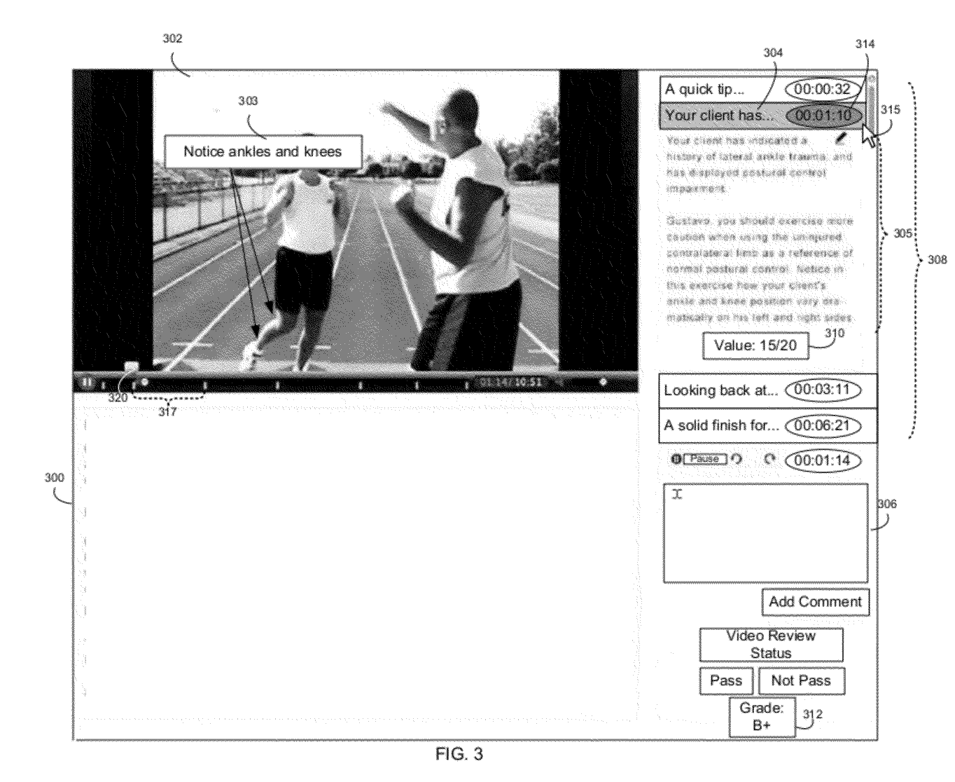

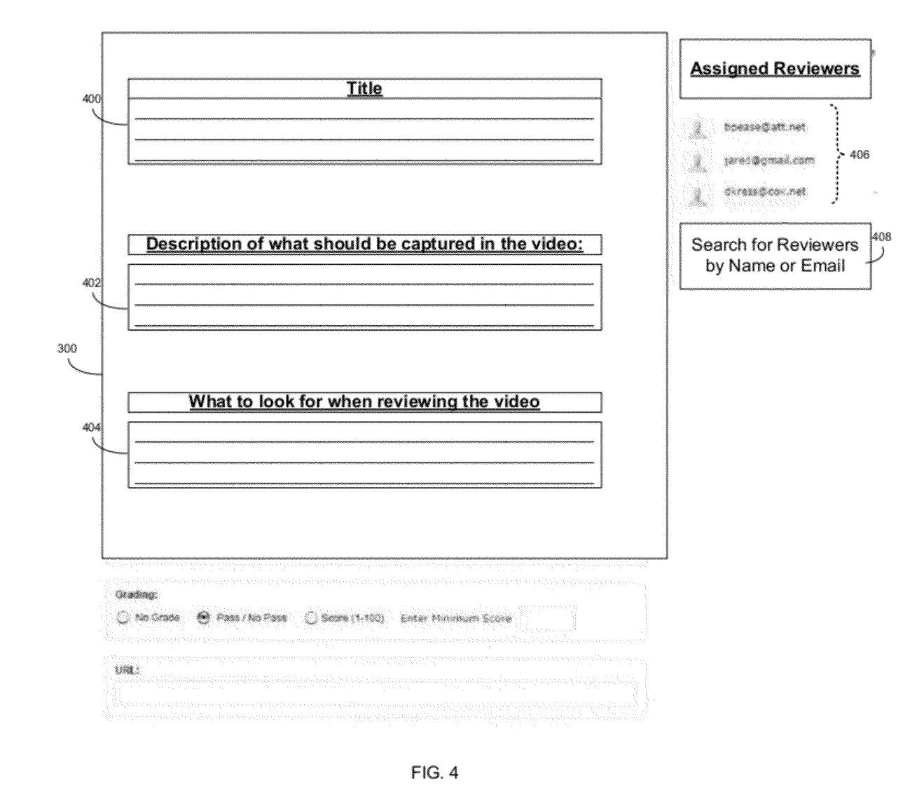

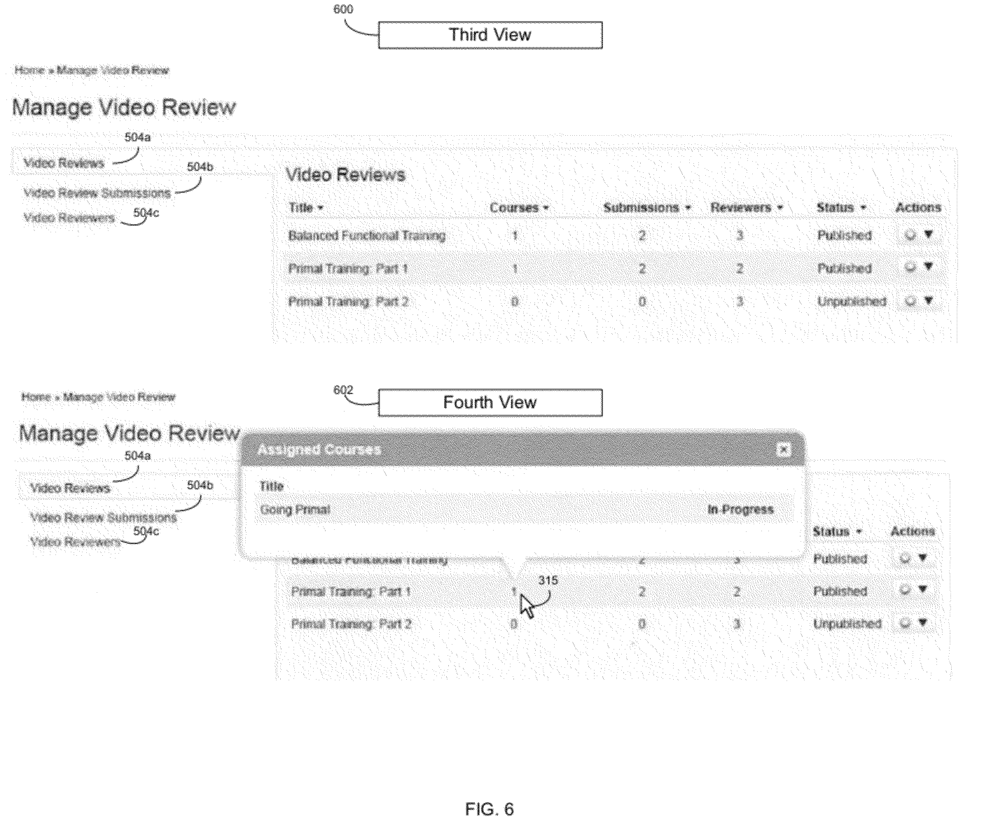

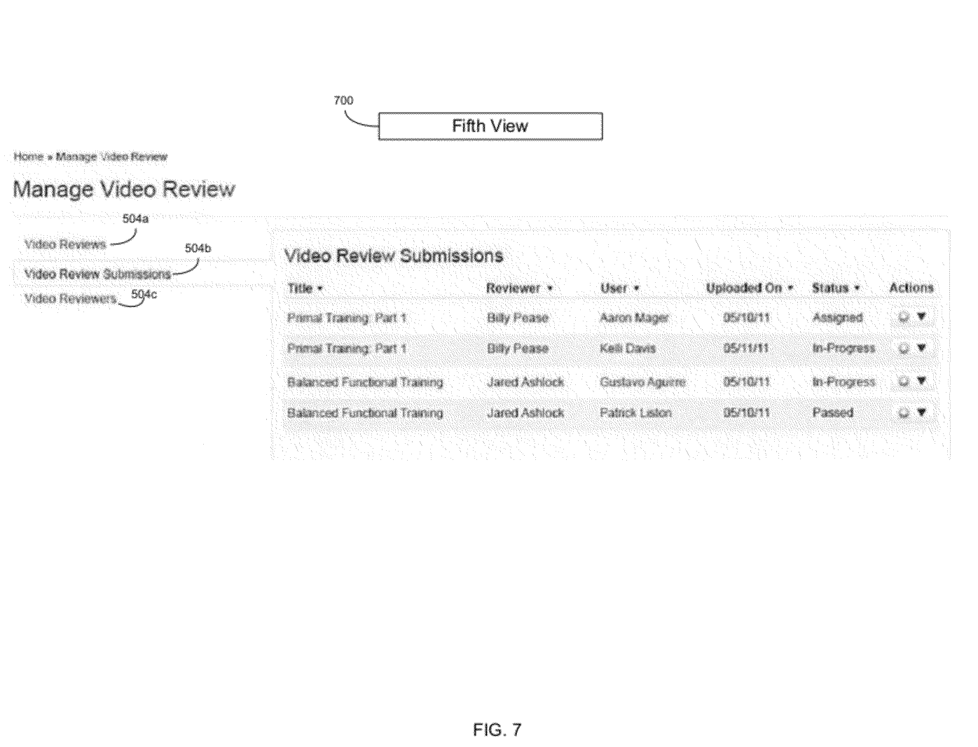

As discussed above and referring also to FIGS. 2-7, feedback process 10 may receive 200 a video (e.g., video 17) at a computer device (e.g., client electronic device 40). A user (e.g., user 48) may be, for example, a student who has created video 17 as part of a project or test to be evaluated by another user (e.g., user 52). User 52 may be a reviewer (e.g., teacher, teaching assistant, colleague, etc.) to “grade” or otherwise provide feedback (e.g., comments) about the content of video 17. According to one embodiment, video 17 may be created at, for example, client electronic device 40 and subsequently uploaded to computer 12 (e.g., to data store 20), for retrieval by feedback process 10 at a later time at client electronic device 44. However, those skilled in the art will appreciate that video 17 may be created at any electronic device (e.g., 12, 38, 40, 42, 44), and be uploaded/retrieved to/from any of the electronic devices (including to external storage) or combinations thereof.

Video 17 may include a plurality of time codes that may correspond to a plurality of video segments of the video. Broadly speaking, a time code may be described as a sequence of numeric codes generated at regular intervals, although the codes need not be numeric and the intervals need not be generated regularly. Examples of time codes may include but are not limited to linear time codes, vertical interval time codes, AES-EBU embedded time codes, burnt-in time codes, CTL time codes, MIDI time codes, and inter-range instrumentation group time codes. Other types of data and/or metadata, such as timestamps, may also be used in addition to or in place of the time codes. As such, the explicit use of time codes and/or timestamps should be taken as an example only and not to limit the scope of the disclosure.

Assume for example purposes only that user 52 is currently reviewing video 17 at client electronic device 44, where video 17 has been previously created by user 48. In the example, feedback process 10 may play 202, via a user interface (e.g., user interface 300) operating on client electronic device 44, at least a portion of video 17 (e.g., one or more video segments of video 17). For example, user interface 300 may include, for instance, a video player (e.g., video player 302) to play 202 video 317. Video player 302 may be used within user interface 300, or alternatively, video player 302 may be included in a separate window (not shown) opened by Feedback process 10 via user interface 300. Video player 302 may be a standard player or any other type of video player capable of viewing video 17.

Further assume that user 52 wishes to comment about a specific video segment (e.g., video segment 317) of the plurality of video segments of video 17. In the example, user 52 may input the comment (e.g., comment 305) corresponding to video segment 317 via user interface 300 and feedback process 10 may receive 204 comment 305 via user interface 300. For example, user interface 300 may include an entry box (e.g., entry box 306) to receive 204 comment 305 from user 52, where feedback process 10 may subsequently receive comment 305 based on the comment 305 received in entry box 306. According to one or more embodiments, user interface 300 may include, for example, a comment list (e.g., comment list 308) to display 214 comment 305, as well as any other comments corresponding to any video segment(s) (e.g., of video 17). Feedback process 10 may enable comment list 308 to be “scrollable” (e.g., assuming each comment in comment list 308 cannot be shown at a single point in time). According to one or more embodiments, similar and/or additional comments (e.g., comment 303) from comment list 308 may be rendered in video player 302. While comment 305 includes text, comment 305 may include text, audio, video, or a combination thereof. Therefore, the example of comment 305 being text based should be taken as an example only and not to limit the scope of the disclosure.

User interface 300 may include, for example, a value (e.g., value 310) of comment 305, and/or a grade (e.g., grade 312) associated with one or more comments associated with video 17 (and/or individual video segments thereof). For instance, assume for example purposes only that video segment 317 has been evaluated by user 52 to lack substance. User 52 may input (e.g., via user interface 300) value 310 and feedback process 10 may receive value 310 via user interface 300 indicating that only 15 out of 20 points have been earned as a result of the lack of substance. In the example, the total value of each comment in comment list 308 may be displayed at user interface 300 (e.g., as grade 312). The total value may be calculated manually by user 52 or may be calculated automatically by feedback process 10.

Further assume in the example that comment 305 corresponds to video segment 317, and further assume that video segment 317 begins at a first time code (e.g., time code 314) of 00:01:10 minutes into video 17 (e.g., time code 314 may correspond to video segment 317). Thus, in the example, comment 305 may be associated 206 by feedback process 10 with time code 314, where time code 314 corresponds to video segment 317.

In the example, feedback process 10 may synchronize 208 comment 314 with playback of video 17. Synchronizing 208 comment 305 with the playback of video 17 may include, for example, feedback process 10 displaying 210 comment 305 associated with time code 314 in-time with the playback of video segment 317 of video 17. For instance, assume for example purposes only that feedback process 10 via user interface 300 begins playing 202 video 17 from the start (e.g., at a time code of 00:00:00). Further assume in the example that until time code 314 of 00:01:10 minutes into video 17 is reached by video player 302, comment 305 is not displayed by feedback process 10. In the example, comment 305 may be displayed 210 at user interface 300 when play of video 17 reaches video segment 317 (i.e., when play of video 17 reaches time code 314 of 00:01:10 minutes into video 17).

According to one or more embodiments, assume instead in the example that only a snippet 304 of comment 305 is shown, but that comment 305 is not displayed by feedback process 10 until time code 314 of 00:01:10 minutes into video 17 is reached by video player 302. In the example, snippet 304 may be “expanded” to display 210 comment 305 at user interface 300 when play of video 17 reaches video segment 317 (i.e., when play of video 17 reaches time code 314 of 00:01:10 minutes into video 17). According to one or more embodiments, feedback process 10 may allow for comment 305 to be manually or automatically scrolled through (e.g., assuming comment 305 cannot be shown in its entirety in its expanded form).

According to one or more embodiments, snippet 304 and/or comment 305 associated with time code 314 may be displayed 214 by feedback process 10 via user interface 300. A selection by user 48 and/or user 52 of snippet 304 and/or comment 305 associated with time code 314 may be received 216 by feedback process 10 via the user interface. For example, user 48 may use, e.g., a curser (e.g., curser 315), to select snippet 304 and/or comment 305. In response to receiving 216 the selection, regardless of which video segment is currently being played 202, feedback process 10 via video player 302 may “jump” play 218 of video 17 to video segment 317 at the corresponding time code (i.e., time code 314). According to one or more embodiments, selection of snippet 304 may result in an expansion of snippet 304 to display 214 comment 305.

According to one or more embodiments a marker (e.g., marker 320) of video 17 may be displayed 220 by feedback process 10 via user interface 300 (e.g., via video player 302). Assume for example purposes only that marker 320 corresponds to time code 314. Further assume that feedback process 10 via user interface 300 receives 222 a selection by user 48 and/or user 52 of marker 320 (e.g., from curser 315). In response to receiving 222 the selection of marker 320, regardless of which video segment is currently being played 202, feedback process 10 via video player 302 may “jump” play 224 of video 17 to video segment 317 at the corresponding time code (i.e., time code 314). According to one or more embodiments, comment 305 associated 206 with time code 314 may be displayed 226 by feedback process 10 via user interface 300 in response to receiving 222 the selection of marker 320.

Feedback process 10, e.g., via user interface 300, may help to manage the reviewers (e.g., user 52). For example, feedback process 10 via user interface 300 may provide an administrator reviewer and/or subordinate reviewer with the ability to assign user 48 to create video 17 for review. According to one or more embodiments, feedback process 10 may enable a search 408 for available reviewers. User interface 300 may include the title of the video project (e.g., title 400), a description of what the students should include in the video (e.g., description 402), and a description of what the reviewer should be looking for when reviewing the video (e.g., description 404). Each assigned reviewer in assigned reviewer list 406 (or alternatively each available assigned reviewer) may be displayed by feedback process 10. Thus, feedback process 10 may enable, e.g., the administrator reviewer, to assign a user (e.g., user 48) to create video 17, and may also enable the administrator reviewer to assign specific reviewers (e.g., user 52) from assigned reviewer list 406 to review video 17.

According to one or more embodiments, a notification (e.g., email, text message, pop-up window, sound, etc.) (not shown) may be received 212 (and/or sent) by feedback process 10 at client electronic device 44 noting that at least some portion of video 17 (e.g., video segment 317) is available for review by user 52. According to one or more embodiments, feedback process 10 may send the notification to inform user 48 that the creation of video 17 has been assigned to user 48.

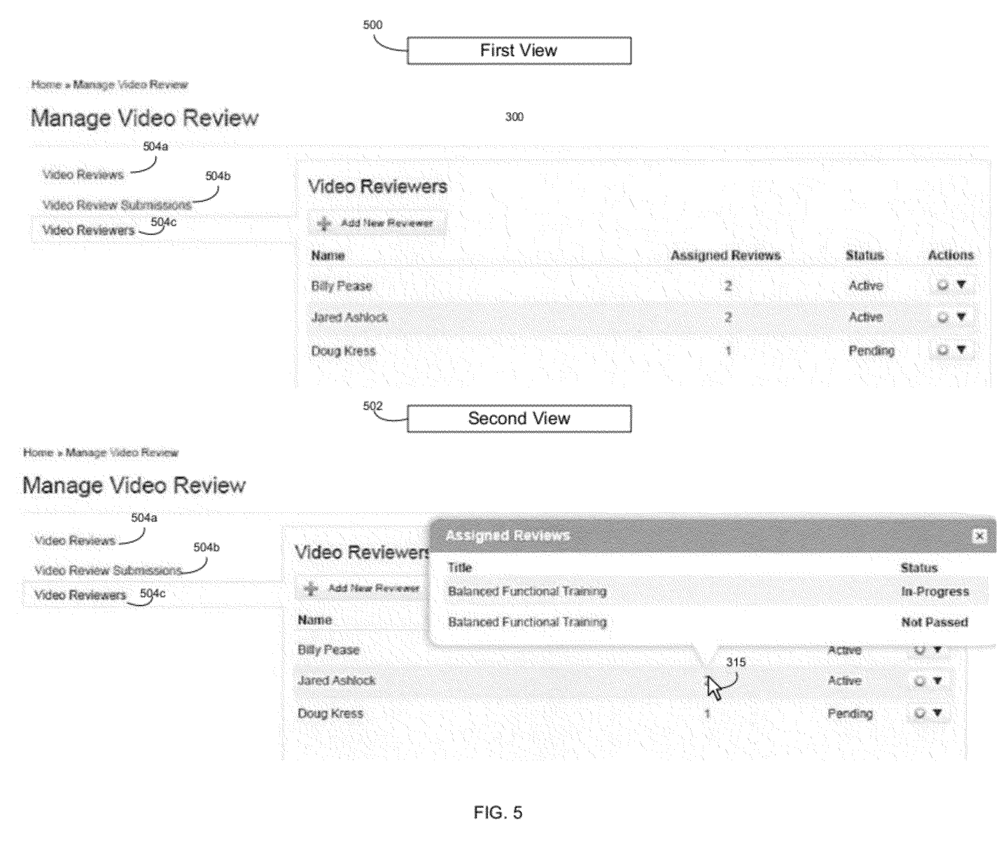

Other examples of feedback process 10 via user interface 300 helping to manage the reviewers may be seen at least by FIGS. 5-7. For instance, a first view 500 of user interface 300 may include one or more tabs (e.g., tabs 504a, 504b, 504c). In the first view, feedback process 10 via tab 504c may present a list of reviewer names, the number of reviews they are each assigned respectively, the status of each assigned review (e.g., assigned, not assigned, in-progress, passed, not passed, etc.), as well as an action to be executed with each assigned review. According to one or more embodiments, in a second view (e.g., second view 502), feedback process 10 via tab 504c may present the titles and associated progress of assigned reviews in response to, for example, hovering curser 315 over the number of reviews shown to be assigned.

According to one or more embodiments, a third view 600 of user interface 300 may include one or more tabs (e.g., tabs 504a, 504b, 504c). In the third view, feedback process 10 via tab 504a may present a list of video review titles, number of courses associated with the video review titles, number of submissions associated with the video review titles, number of reviewers associated with the video review titles, the status associated with the video review titles, as well as an action to be executed with each assigned review. According to one or more embodiments, in a fourth view (e.g., fourth view 502), feedback process 10 via tab 504a may present the titles and associated progress of assigned courses in response to, for example, hovering curser 315 over the number of reviews shown to be assigned.

According to one or more embodiments, a fifth view 700 of user interface 300 may include one or more tabs (e.g., tabs 504a, 504b, 504c). In the fifth view, feedback process 10 via tab 504b may present a list of video review titles, a list of corresponding reviewer names, the name of the user (e.g., user 48) that created the video for review, the date and/or time that the video to be reviewed was uploaded, the status associated with the video review titles, as well as an action to be executed with each assigned review.

While one or more embodiments may be described in terms of reviewing a video, those skilled in the art will recognize that any type of media, such as audio, may be used. As such, the description of a video should be taken as an example only and not to limit the scope of the disclosure. Additionally, those skilled in the art will recognize that other configurations of user interface 300 may be implemented without departing from the scope of the disclosure. As such, the specific designs and implementations of user interface 300 should be taken as an example only and not to limit the scope of the disclosure.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The embodiment(s) were chosen and described in order to best explain the principles of the disclosure and the practical application, and to enable others of ordinary skill in the art to understand the disclosure for various embodiment(s) with various modifications and/or any combinations of embodiment(s) as are suited to the particular use contemplated.

Having thus described the disclosure of the present application in detail and by reference to embodiment(s) thereof, it will be apparent that modifications, variations, and any combinations of embodiment(s) (including any modifications, variations, and combinations thereof) are possible without departing from the scope of the disclosure defined in the appended claims.

What is claimed is:

1. A computer-implemented method comprising:
receiving a video at a computer device, the video including a plurality of time codes corresponding to a plurality of video segments of the video;
playing at least a portion of the plurality of video segments via a user interface operating on the computer device;
receiving a comment corresponding to a first video segment of the plurality of video segments via the user interface;
associating the comment with a first time code of the plurality of time codes, the first time code corresponding to the first video segment; and
synchronizing the comment with playback of the video.

2. The computer-implemented method of claim 1 wherein synchronizing the comment with the playback of the video includes displaying the comment associated with the first time code in-time with the playback of the first video segment of the video.

3. The computer-implemented method of claim 1 further comprising:
displaying the comment associated with the first time code via the user interface;
receiving a selection of the comment associated with the first time code via the user interface; and
playing the first video segment at the corresponding first time code in response to receiving the selection of the comment.

4. The computer-implemented method of claim 1 further comprising:
displaying a marker of the video via the user interface, the marker corresponding to the first time code;
receiving a selection of the marker of the video corresponding to the first time code via the user interface;
playing the first video segment at the corresponding first time code in response to receiving the selection of the marker; and
displaying the comment associated with the first time code via the user interface in response to receiving the selection of the marker.

5. The computer-implemented method of claim 1 wherein the comment includes at least one of text, audio, and video.

6. The computer-implemented method of claim 1 further comprising receiving a notification at the computer device that at least the portion of the video is available for review.

7. The computer-implemented method of claim 1 wherein the user interface includes at least one of a video player, an entry box to receive the comment, a comment list to display the comment, a value of the comment, and a grade.

8. A computer program product residing on a computer readable storage medium having a plurality of instructions stored thereon which, when executed by a processor, cause the processor to perform operations comprising:
receiving a video, the video including a plurality of time codes corresponding to a plurality of video segments of the video;
playing at least a portion of the plurality of video segments via a user interface;
receiving a comment corresponding to a first video segment of the plurality of video segments via the user interface;
associating the comment with a first time code of the plurality of time codes, the first time code corresponding to the first video segment; and
synchronizing the comment with playback of the video.

9. The computer program product of claim 8 wherein synchronizing the comment with the playback of the video includes displaying the comment associated with the first time code in-time with the playback of the first video segment of the video.

10. The computer program product of claim 8 wherein the operations further comprise:
displaying the comment associated with the first time code via the user interface;
receiving a selection of the comment associated with the first time code via the user interface; and
playing the first video segment at the corresponding first time code in response to receiving the selection of the comment.

11. The computer program product of claim 8 wherein the operations further comprise:
displaying a marker of the video via the user interface, the marker corresponding to the first time code;
receiving a selection of the marker of the video corresponding to the first time code via the user interface;
playing the first video segment at the corresponding first time code in response to receiving the selection of the marker; and
displaying the comment associated with the first time code via the user interface in response to receiving the selection of the marker.

12. The computer program product of claim 8 wherein the comment includes at least one of text, audio, and video.

13. The computer program product of claim 8 wherein the operations further comprise receiving a notification that at least the portion of the video is available for review.

14. The computer program product of claim 8 wherein the user interface includes at least one of a video player, an entry box to receive the comment, a comment list to display the comment, a value of the comment, and a grade.

15. A computing system including a processor and memory configured to perform operations comprising:
receiving a video, the video including a plurality of time codes corresponding to a plurality of video segments of the video;
playing at least a portion of the plurality of video segments via a user interface;
receiving a comment corresponding to a first video segment of the plurality of video segments via the user interface;
associating the comment with a first time code of the plurality of time codes, the first time code corresponding to the first video segment; and
synchronizing the comment with playback of the video.

16. The computing system of claim 15 wherein synchronizing the comment with the playback of the video includes displaying the comment associated with the first time code in-time with the playback of the first video segment of the video.

17. The computing system of claim 15 wherein the operations further comprise:
displaying the comment associated with the first time code via the user interface;
receiving a selection of the comment associated with the first time code via the user interface; and
playing the first video segment at the corresponding first time code in response to receiving the selection of the comment.

18. The computing system of claim 15 wherein the operations further comprise:
displaying a marker of the video via the user interface, the marker corresponding to the first time code;
receiving a selection of the marker of the video corresponding to the first time code via the user interface;
playing the first video segment at the corresponding first time code in response to receiving the selection of the marker; and
displaying the comment associated with the first time code via the user interface in response to receiving the selection of the marker.

19. The computing system of claim 15 wherein the comment includes at least one of text, audio, and video.

20. The computing system of claim 15 wherein the operations further comprise receiving a notification that at least the portion of the video is available for review.

21. The computing system of claim 15 wherein the user interface includes at least one of a video player, an entry box to receive the comment, a comment list to display the comment, a value of the comment, and a grade.
